(19) United States
(12) Patent Application Publication
(10) Pub. No.: US 2024/0424660 A1
(43) Pub. Date: Dec. 26, 2024

(54) TOOL STORAGE DEVICE AND SYSTEM AND HAND TOOL

(71) Applicant: TECHTRONIC CORDLESS GP, Anderson, SC (US)

(72) Inventors: Jeremy Fedrigon, Greenville, SC (US); Collin C. Burney, Greenville, SC (US); Charles M. Wacker, III, Anderson, SC (US)

(21) Appl. No.: 18/482,269

(22) Filed: Oct. 6, 2023

Related U.S. Application Data
(60) Provisional application No. 63/510,183, filed on Jun. 26, 2023.

(51) Int. Cl. B25G 1/08; B25B 23/00

(52) U.S. Cl. CPC B25G 1/085; B25B 23/0035; B25B 15/04

(57) ABSTRACT

A hand tool, a tool storage device, and a modular bit storage device are provided. The tool storage device includes a base including a shaft extending from an interior surface. A tool holder is coupled to the shaft and includes a plurality of wings extending radially outward relative to the shaft and along a longitudinal direction. A plurality of channels is formed between respective pairs of wings of the plurality of wings. The channels are positioned in adjacent circumferential arrangement. The tool holder forms a center bore into which the shaft is positionable and fastened to the tool holder. The tool holder is selectively positionable to a body of the hand tool, a cap of the modular bit storage device, or both.

### PRIORITY STATEMENT

The present disclosure claims the benefit of priority to U.S. provisional patent application No. 63/510,183, filed on Jun. 26, 2023, titled “RATCHETING SCREWDRIVER AND TOOL STORAGE DEVICE”, the disclosure of which is incorporated by reference in its entirety.

### FIELD

The present disclosure generally pertains to hand-held tools, and particularly to screwdrivers, tool storage systems, and tool storage devices for tool bits for hand-held tools.

### BACKGROUND

Screwdrivers require turning by a user and storage of tool bits. However, bulky assemblies may inhibit usability of the screwdriver, tool bit storage, or torque application by a user (e.g., in tight spaces).

Screwdrivers require various tool bits for different types of fasteners. A user generally desires to have various tool bits easily and quickly accessible. However, bulky toolboxes may cause tool bits to be difficult to retrieve.

Screwdrivers, tool storage devices, and tool storage systems that address one or more of these issues would be advantageous and beneficial.

### SUMMARY

Aspects and advantages of the invention will be set forth in part in the following description, may be apparent from the description, or may be learned through practice of the invention.

An aspect of the present disclosure is directed to a tool storage device. The tool storage device includes a base including a shaft extending from an interior surface. A tool holder is coupled to the shaft and includes a plurality of wings extending radially outward relative to the shaft and along a longitudinal direction. A plurality of channels is formed between respective pairs of wings of the plurality of wings and extends along the longitudinal direction. The plurality of channels is positioned in adjacent circumferential arrangement. The tool holder forms a center bore into which the shaft is positionable and fastened to the tool holder.

Another aspect of the present disclosure is directed to a tool storage system. The tool storage system includes a tool storage device, a cap, and a hand tool. The tool storage device includes a base and a tool holder. The base includes a shaft extending from an interior surface. The tool holder is coupled to the shaft. The tool holder includes a plurality of wings extending radially outward relative to the shaft and along a longitudinal direction. A plurality of channels is formed between respective pairs of wings of the plurality of wings and extends along the longitudinal direction. The plurality of channels is positioned in adjacent circumferential arrangement. The tool holder forms a center bore into which the shaft is positionable and fastened to the tool holder. The cap forms a cap interior volume into which the tool storage device is positionable through a cap opening. The cap is elongated along the longitudinal direction and includes a cap internal end wall. The cap interior volume extends between the base of the tool storage device and the cap internal end wall. The hand tool includes a body forming a body interior volume into which the tool storage device is positionable through a body opening. The body is elongated along the longitudinal direction and includes a body internal end wall. The body interior volume extends between the base of the tool storage device and the body internal end wall. The body includes a tool head retainer distal along the longitudinal direction from the body opening through which the tool storage device is positionable into the body. The tool head retainer is configured to receive a tool head at which a tool bit is receivable.

Yet another aspect of the present disclosure is directed to a hand tool. The hand tool includes a tool storage device and a body. The tool storage device includes a base and a tool holder. The base includes a shaft extending from an interior surface. The tool holder is coupled to the shaft. The tool holder includes a plurality of wings extending radially outward relative to the shaft and along a longitudinal direction. A plurality of channels is formed between respective pairs of wings of the plurality of wings and extends along the longitudinal direction. The plurality of channels is positioned in adjacent circumferential arrangement. The tool holder forms a center bore into which the shaft is positionable and fastened to the tool holder. The body forms an interior volume into which the tool storage device is positionable through a body opening. The body is elongated along the longitudinal direction and includes a body internal end wall. The body interior volume extends between the base of the tool storage device and the body internal end wall. The body includes a tool head retainer distal along the longitudinal direction from the body opening through which the tool storage device is positionable into the body. The tool head retainer is configured to receive a tool head at which a tool bit is receivable.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a side view of an embodiment of a hand tool including a tool storage device attached thereto in accordance with aspects of the present disclosure;

FIG. 2 provides a side view of the hand tool of FIG. 1 with an embodiment of the tool storage device extended from a body in accordance with aspects of the present disclosure;

FIG. 3 provides a side view of the hand tool of FIG. 1 with an embodiment of the tool storage device positioned in the body, in which the body is transparent, in accordance with aspects of the present disclosure;

FIG. 4 provides a side cross section view of the hand tool of FIG. 1 with an embodiment of the tool storage device positioned in the body, in which the body is transparent, in accordance with aspects of the present disclosure;

FIG. 5 provides a perspective view of an embodiment of the body of the hand tool in accordance with aspects of the present disclosure;

FIG. 6 provides a transparent perspective view of an embodiment of the body of the hand tool including an embodiment of the tool storage device positioned within the body in accordance with aspects of the present disclosure;

FIG. 7 provides a side cross sectional view of an embodiment of the body of the hand tool in accordance with aspects of the present disclosure;

FIG. 8 provides a side view of an embodiment of a modular bit storage device including a tool storage device attached thereto in accordance with aspects of the present disclosure;

FIG. 9 provides a side view of the modular bit storage device of FIG. 8 with an embodiment of the tool storage device extended from a body in accordance with aspects of the present disclosure;

FIG. 10 provides a perspective view of an embodiment of a tool storage device in accordance with aspects of the present disclosure;

FIG. 11 provides a cutaway perspective view of an embodiment of the tool storage device of FIG. 10 in accordance with aspects of the present disclosure;

FIG. 12 provides a side view of the tool storage device of FIG. 10 in accordance with aspects of the present disclosure;

FIG. 13 provides a perspective view of an embodiment of the tool storage device in accordance with aspects of the present disclosure;

FIG. 14 provides a perspective view of an embodiment of the tool storage device in accordance with aspects of the present disclosure;

FIG. 15 provides a perspective view of an embodiment of the tool storage device in accordance with aspects of the present disclosure;

FIG. 16 provides a side view of the embodiment of the tool storage device of FIG. 15 in accordance with aspects of the present disclosure;

FIG. 17 provides a perspective view of an embodiment of a tool holder of a tool storage device in accordance with aspects of the present disclosure;

FIG. 18 provides an end view of the tool holder of FIG. 17 in accordance with aspects of the present disclosure;

FIG. 19 provides a perspective view of an embodiment of a tool holder of a tool storage device in accordance with aspects of the present disclosure;

FIG. 20 provides an end view of the tool holder of FIG. 19 in accordance with aspects of the present disclosure; and

FIG. 21 provides an embodiment of a tool storage system including an embodiment of a hand tool with an embodiment of the tool storage device extended from a body, and an embodiment of a modular bit storage device with an embodiment of the tool storage device extended from a cap, in accordance with aspects of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

Dimensions provided herein may include approximations of +/−2% of any discrete quantity, or approximations of +2% of a maximum value over a given range or −2% of the maximum value under the given range, unless otherwise provided herein.

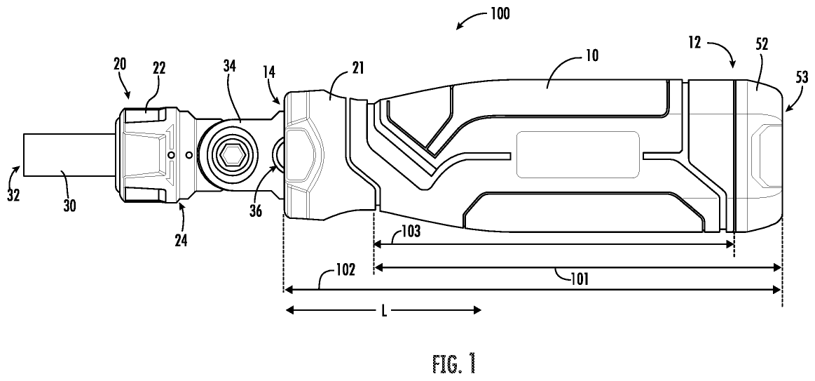

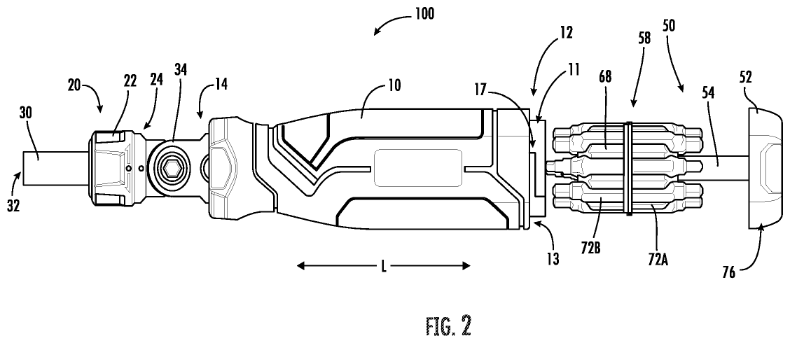

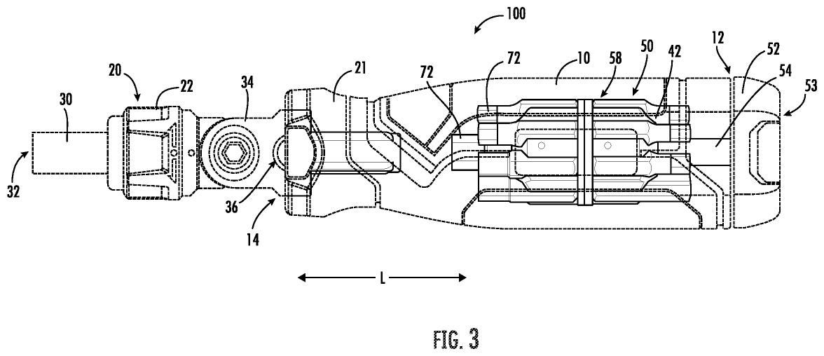

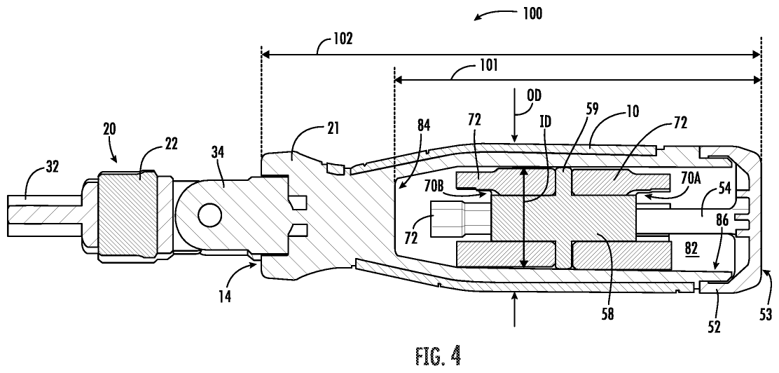

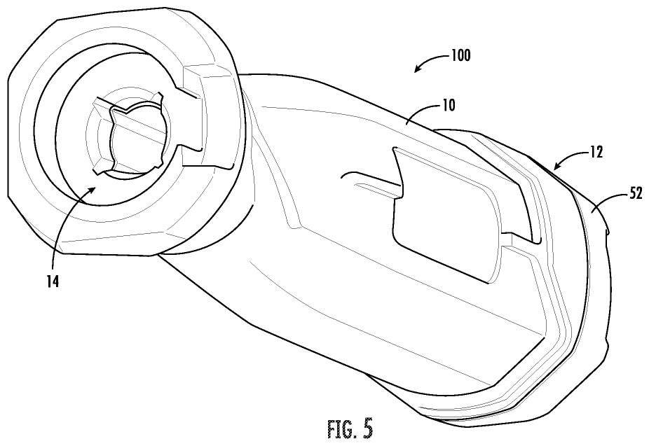

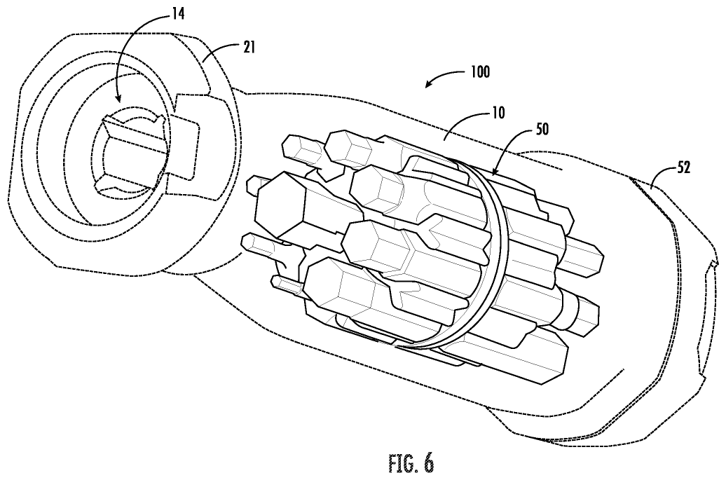

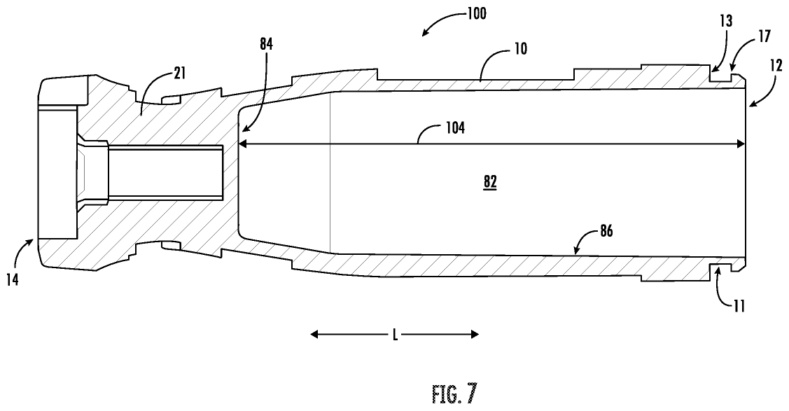

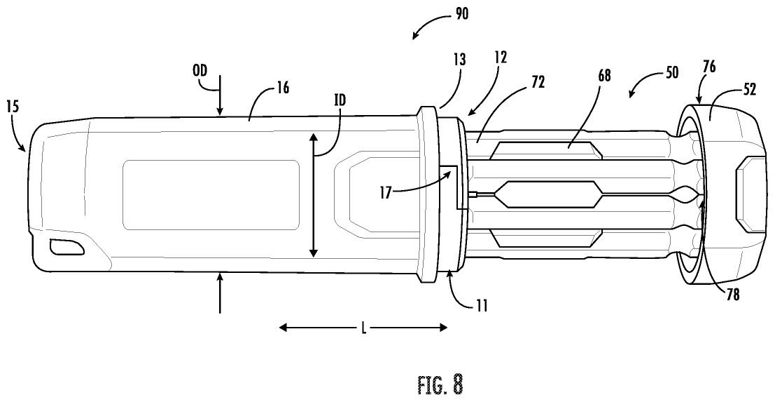

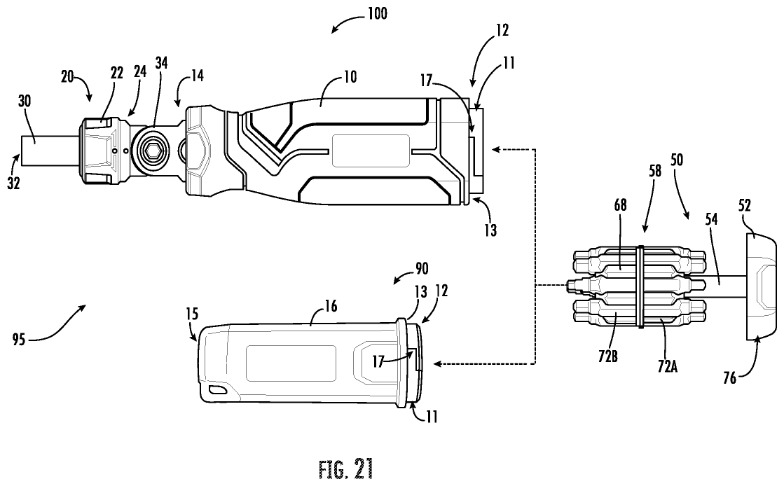

Embodiments of a tool storage device 50 (FIG. 2), a modular bit storage device 90 (FIG. 8) and a manipulatable hand tool 100 (FIG. 1), such as a screwdriver, are provided herein that overcome issues described above and provide benefits such as described herein. Embodiments of the device 90 and hand tool 100 may form a tool storage system 95 (FIG. 21) that overcomes issues and provide benefits such as described herein. Referring now to FIGS. 1-7, various embodiments of the hand tool 100 include a body 10 forming an interior volume 82 (FIG. 7) into which the tool storage device 50 is receivable. The body 10 is elongated along a longitudinal direction L. The body 10 may form a substantially cylindrical structure, or include a multi-faceted (e.g., polygonal) outer surface. In some embodiments, such as depicted in FIGS. 1-7, the body 10 includes a first end opening 14 separated along the longitudinal direction L from a second end opening 12. Various embodiments of the body 10 form an interior volume 82 configured to receive and store tool bits 72 attached to the tool storage device 50. Various embodiments of the tool bit 72 may include, but not limited to, driver bits, such as, but not limited to, flat head, hex head, square head, Phillips head, Phillips driving, Allen head, star or Torx® bit, and/or the like, such as further described herein. Embodiments of the hand tool 100 may be configured with any appropriate or desired tool bit size, such as corresponding to the tool bits 72 (FIG. 3) receivable at, on, or in the tool storage device 50.

In some embodiments, body 10 forms a unitary, monolithic structure. In still some embodiments, body 10 forms a multi-piece assembly. For instance, body 10 may include a two-piece assembly of halves, such as halves including snapping interfaces connectable to one another. For instance, body 10 may include halves split along the longitudinal direction L. However, it should be appreciated that body 10 may include more than two portions, such as, but not limited to, three portions, or four portions, etc.

Referring to FIGS. 1-6, in some embodiments, body 10 forms at least a portion of the hand tool 100. The hand tool 100 includes a head 20. The head 20 may form a ratcheting head including a ratchet mechanism 22. For instance, the ratchet mechanism 22 may include a bar or wheel with a plurality of angled teeth at which a tooth engages, such as to allow motion is a first direction (e.g., a first circumferential direction, such as clockwise). The ratchet mechanism 22 may include a switch or other device configured to allow motion in a second direction (e.g., a second circumferential direction, such as counter-clockwise). The ratchet mechanism 22 may include any appropriate type of ratcheting mechanism, such as may allow rotation in a circumferential direction and inhibit rotation in an opposite direction, and my further allow for switching of the desired direction of rotation.

The head 20 includes a tool bit shaft 30 connected to the ratchet mechanism 22. The shaft 30 includes a tool bit opening 32 configured to receive a tool bit, such as described above. The tool bit is selectively placed and removed from the shaft 30 via opening 32.

The head 20 includes a key 34 extending from the ratchet mechanism 22. For instance, the key 34 may extend opposite from an extension of the shaft 30. The key 34 includes a detent 36, such as may be configured as a ball detent. The detent 36 is configured to retain the head 20 to the body 10 at the opening 14, and at cap 52. The first opening 14 is configured to correspond to the key 34, such as to selectively receive the key 34 and retain to the body 10 via the detent 36.

Various embodiments of the detent 36 may include a ball positioned within an opening at the key 34. The ball is configured to displace within the opening such as to allow the key 34 and detent 36 to extend through the opening 14. Opening 14 may include a sleeve positioned therewithin, such as configured to receive the detent 36. For instance, detent 36 may be configured to allow an aft end 24 of the ratcheting mechanism 22 to position flush or substantially flush to a face at which opening 14 is formed.

First end opening 14 allows the key 34 to extend co-directional to the longitudinal direction L, such as to position the shaft 30 and tool bit extending co-directional to the longitudinal direction L. Body 10 may extend such as to provide a longitudinally-elongated handle by which a user may manually rotate and operate the head 20. For instance, body 10 may extend co-directional or coaxial to the shaft 30 and tool bit attached thereto.

In various embodiments, opening 14 corresponds to key 34, such as corresponding in depth, length, and width to allow the key 34 to position within the opening 14. For instance, opening 14 may form a rectangular or substantially rectangular opening. It should be appreciated that opening 14 may form other polygonal or geometric formations, such as, but not limited to, star, cross, triangular, hexagonal, etc., geometries.

Referring to FIGS. 1-4, the second end opening 12 of the body 10 forms a locking interface configured to receive an end cap or base 52 of the tool storage device 50. In various embodiments, the locking interface includes a substantially longitudinally extended face 11 configured to extend into a portion of the base 52 and a substantially radially extended face 13 at which the base 52 may abut to the body 10 along the longitudinal direction L.

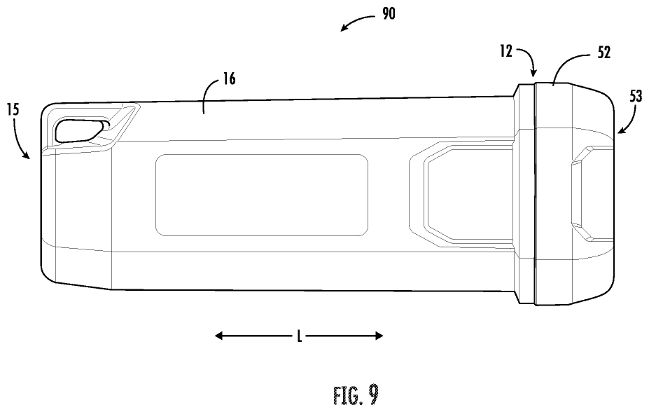

Referring to FIGS. 8-9, embodiments of the modular bit storage device 90 includes a cap 16 configured substantially similarly as embodiments of the body 10. For instance, cap 16 may form a cylindrical or multi-faceted body extending along the longitudinal direction and including the second end opening 12, such as described in regard to body 10. It should be appreciated that embodiments of the cap 16 may include portions, dimensions, volumes, and the like, of one or more embodiments of the body 10, such as described herein. Cap 16 includes a closed end 15 opposite of the second end opening 12.

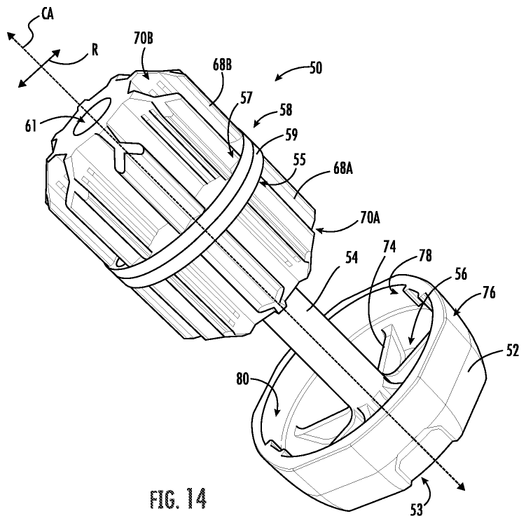

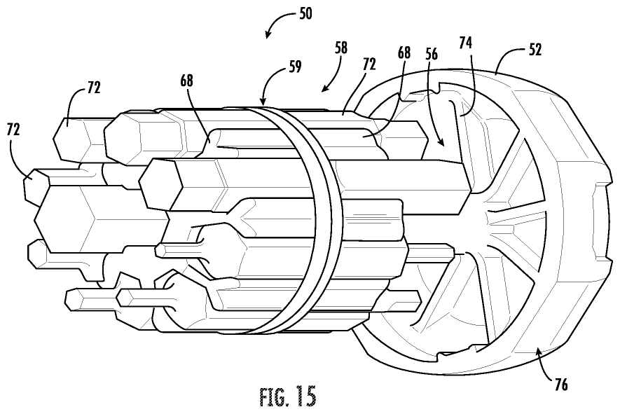

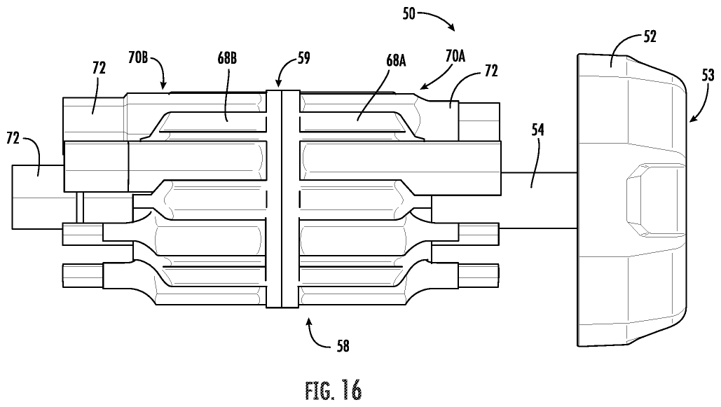

Referring now to FIGS. 10-20, embodiments of a tool storage device 50 are provided. Embodiments of the tool storage device 50 may include a shaft 54 extending longitudinally from the base 52, such as corresponding to the longitudinal extension of the body 10 or cap 16 along longitudinal direction L. In various embodiments, shaft 54 extends from an interior surface 56 of the base 52, such as to extend through opening 12 into the internal volume of the body 10 or cap 16.

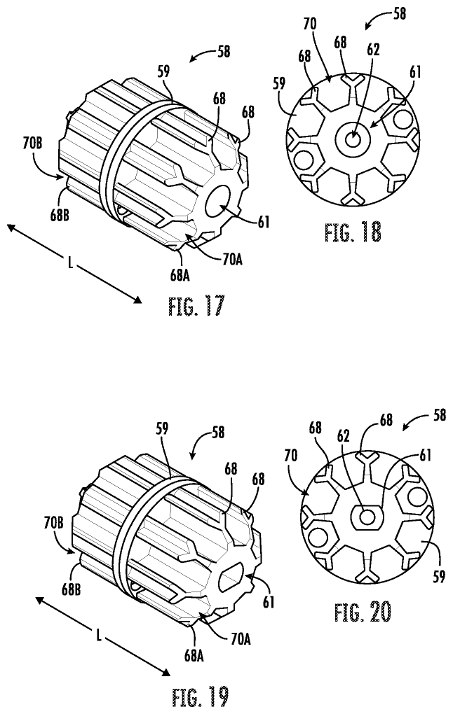

A tool holder 58 is coupled to the shaft 54. In various embodiments, the tool holder 58 is selectively releasable from the shaft 54. In some embodiments, the tool holder 58 is integral with the shaft 54. For instance, the tool holder 58 and shaft 54 may form a unitary, monolithic component. A fastener 60 may retain the tool holder 58 to the shaft 54. In some embodiments, the shaft 54 includes a center bore 62 into which the fastener 60 is extendable. The center bore 62 may be configured to receive threads at the fastener 60. Accordingly, the fastener 60 and center bore 62 may form a threaded interface coupling the fastener 60 to the shaft 54. The tool holder 58 may be retained onto the shaft 54 by placing a head 64 at the fastener 60 against a mating surface 66 at the tool holder 58. The mating surface 66 is positioned between the head 64 and the shaft 54, such as to retain the tool holder 58 to the shaft 54. Fastener 60 is extendable through a center bore 61 at the tool holder 58 to attach the fastener 60 against the mating surface 66. Center bore 61 may form a substantially circular bore (e.g., depicted at FIGS. 17-18), or an elliptical or racetrack cross-section bore (e.g., depicted at FIGS. 19-20), or other cross section, such as may be appropriate to receive a tool bit.

The tool holder 58 includes a plurality of ribs or wings 68 extending radially outward relative to the shaft 54. For instance, shaft 54 and bores 61, 62 may extend along a centerline axis CA co-directional to the longitudinal direction L when positioned into the body 10 or cap 16. A radial direction R extends from the centerline axis CA. Wings 68 extend along longitudinal direction L co-directional to the centerline axis CA and are positioned in adjacent circumferential arrangement around the centerline axis CA. One or more pair of wings 68 forms a slot or channel 70 extending co-directional to the centerline axis CA. A tool bit 72 may be releasably attachable between the wings 68 at channel 70, such that wings 68 securely hold the tool bit 72 in and/or against the channel 70. Opposing wings 68 may “open” via flexing away from each other across the channel 70 during insertion of the tool bit 72 into the channel 70. The opposing wings 68 may then “close” about the tool bit 72 by flexing towards each other across the channel 70 to secure the tool bit 72 in the channel 70.

In some embodiments, fastener 60 is selectively extendable into shaft 54 at bore 62, such as to adjust an extension of the fastener 60 along the centerline axis CA. For instance, head 64 may be selectively positioned along the centerline axis CA, such as to adjust a distance of the head 64 relative to the interior surface 56 of the base 52. Adjustment of the head 64 position may allow for adjustment along the centerline axis CA of the tool holder 58. Adjustment of the tool holder 58 along the centerline axis CA may allow for tool bits 72 of various lengths to be positioned onto the tool holder 58.

In some embodiments, bore 61 forms a tool bit opening configured to receive a tool bit 72. Bore 61 may carry the tool bit 72. Additionally, bore 61 allows the tool storage device 50 to be utilized as a hand tool, such as a screwdriver, when a tool bit is secured into the bore 61. For instance, bore 61 may include walls forming a fitted interface (e.g., tight fit, interference fit, etc.) configured to secure the tool bit into the bore 61.

In some embodiments, the base 52 forms a rib 74 at the interior surface 56. The rib 74 extends between the shaft 54 and a perimeter wall 76 of the base 52. The perimeter wall 76 forms a head at which a user may grab, handle, and articulate the tool storage device 50 (e.g., such as to position and remove the tool holder device 50 at the body 10 or cap 16). The rib 74 extends from the interior surface 56 to support the tool bit 72 at the base 52. For instance, rib 74 may be formed to offset the tool bit 72 from positioning flat onto the interior surface 56.

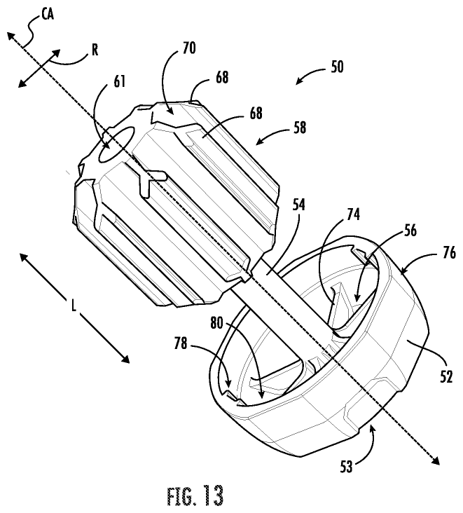

Referring to FIGS. 13-14, the base 52 includes an interior wall 80 configured to abut and correspond to the longitudinally extended face 11 at the body 10 or cap 16 when the base 52 is affixed to the body 10 (FIGS. 1 and 3-4) or cap 16 (FIG. 9). The locking interface includes a lock key 78 positioned at the interior wall 80. The lock key 78 includes a raised wall, groove, or tooth. For instance, the lock key 78 may extend at least partially co-directional to the centerline axis CA. The lock key 78 may be positioned at a longitudinal end along the interior wall 80 distal to the interior surface 56. Face 11 forms a keyway 17 configured to receive the lock key 78. The keyway 17 includes a raised surface or groove configured to receive a corresponding groove or raised wall formed by the lock key 78. The keyway 17 may form a wall extending along a circumferential direction along face 11. The keyway 17 may form a wall extending along the longitudinal direction L along face 11 to face 13 from the circumferentially extending portion. A user may slide the base 52 to the body 10 or cap 16 along the longitudinal direction L and turn the base 52 to affix the lock key 78 within the keyway 17. For instance, the keyway 17 may extend along an arc (e.g., three-quarter turn, a half turn, a quarter turn, or less, or other desired arc along face 11) and secure the lock key 78 within the keyway 17 when turned.

Referring to FIGS. 1-20, various embodiments of the tool storage device 50, tool holder 58, modular bit storage device 90, and hand tool 100 each include ranges and ratios that advantageously and beneficially promote retention of a plurality of tool bits 72. In some embodiments, ranges and ratios provided herein may allow the tool holder 58 to retain the plurality of tool bits 72 at channels 70, or furthermore, retain a tool bit 72 at bore 61 to allow the tool storage device 50 to be utilized as a screwdriver or similar tool.

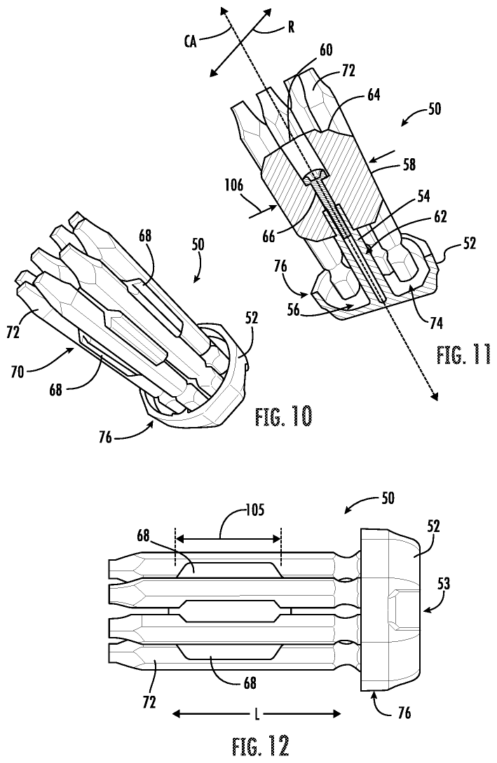

In various embodiments, tool holder 58 is configured to retain eight (8) tool bits 72 at a respective quantity of channels 70 formed between wings 68. In various embodiments, wings 68 extend between approximately 27 millimeters and approximately 37 millimeters along the longitudinal direction L, such as depicted at dimension 105 (FIG. 12). The tool holder 58 extends approximately 27 millimeters in diameter relative to the centerline axis CA, such as depicted at diameter 106 (FIG. 11). In various embodiments, a ratio of diameter of tool holder 58 to length of wing 68 ranges between approximately 1:1 and approximately 27:37. In still various embodiments, shaft 54 extends approximately 34.5 millimeters along the longitudinal direction L. Shaft 54 may extend approximately 6.5 mm in diameter relative to the centerline axis CA. Various embodiments of the shaft 54, or portions thereof, may include a draft at which the diameter varies.

Referring to FIGS. 10-12, in some embodiments, tool holder 58 includes wings 68 extending by approximately 27 millimeters along the longitudinal direction L to retain eight (8) 2.5-inch (2.5″) tool bits at eight (8) channels 70. A ratio of diameter of tool holder 58 to length of wing 68 is approximately 1:1.

Referring to FIGS. 10-20, in some embodiments, tool holder 58 includes wings 68 extending by approximately 37 millimeters along the longitudinal direction L to retain sixteen (16) one-inch (1″) tool bits at sixteen (16) channels 70. A dividing member, such as a plate or divider 59 extends from the centerline axis CA and separates two sets of wings 68A, 68B along the longitudinal direction L. Each set of wings 68A, 68B forms eight (8) channels in circumferential arrangement relative to the centerline axis CA. The two sets of wings 68A, 68B are separated along the longitudinal direction L by wall 59 to form sixteen (16) channels 70A, 70B to receive a respective quantity of tool bits 72. A ratio of diameter of tool holder 58 to length of wing 68 is approximately 27:37.

For instance, divider 59 may extend from centerline axis CA, such as along the radial direction R. A first plurality of wings 68A extends along the longitudinal direction L from a first portion 55 of the divider 59. A second plurality of wings 68B extends along the longitudinal direction L from a second portion 57 of the divider 59. In some embodiments, two pair of eight (8) channels 70 in circumferential arrangement relative to the centerline axis CA is formed between pairs of wings 68. A first set of eight (8) channels 70A is formed extended along the longitudinal direction L from the first portion 55. A second set of eight (8) channels 70B is formed extending along the longitudinal direction L from the second portion 57.

The following tables outline exemplary bit types and sizes for tool bit 72 such as described herein. Sizes outlined herein may include one-inch (1″) lengths, 2.5 inch lengths, or other compatible sizes. Diameters may include quarter-inch (¼″) or other compatible sizes.

| | |
|---|---|
| HEX | |
| MM | 1″ BITS |

| | | |
|---|---|---|
| 1.5 | mm | 1 |
| 2 | mm | 1 |
| 2.5 | mm | 1 |
| 3 | mm | 1 |
| 4 | mm | 1 |
| 5 | mm | 1 |
| 5.5 | mm | 1 |
| 6 | mm | 1 |
| 8 | mm | 1 |

| HEX | |
|---|---|
| SAE | 1″ BITS |
| 5/64″ | 1 |
| 3/32″ | 1 |
| 7/64″ | 1 |
| ⅛″ | 1 |
| 9/64″ | 1 |
| 5/32″ | 1 |
| 3/16″ | 1 |
| ¼″ | 1 |

| PHILLIPS | 1″ BITS |
|---|---|
| PH0 | 1 |
| PH1 | 1 |
| PH2 | 2 |
| PH3 | 1 |

| SQUARE | 1″ BITS |
|---|---|
| SQ1 | 1 |
| SQ2 | 1 |
| SQ3 | 1 |

| STAR | 1″ BITS |
|---|---|
| T10 | 1 |
| T15 | 1 |
| T20 | 1 |
| T25 | 1 |
| T30 | 1 |

| STANDARD | |
|---|---|
| OR FLAT | 1″ BITS |
| SL ¼″ | 1 |
| SL 3/16″ | 1 |
| SL 7/32″ | 1 |

HEX NUT DRIVER

| | |
|---|---|
| 5/16″ | 1 |

In an exemplary non-limiting embodiment, the tool holder 58 is configured substantially as depicted in FIGS. 10-12, and further configured to receive sixteen (16) 2.5″ tool bits configured as SAE 5/54″, 3/32″, 7/64″, ⅛″, 9/64″, 5/32″, 3/16″, ¼″ or metric 1.5 mm, 2 mm, 2.5 mm, 3 mm, 4 mm, 5 mm, 5.5 mm, 6 mm sizes, or combinations thereof. For instance, pairs of tool bits 72 may be positioned in each channel 70 in adjacent arrangement along the longitudinal direction L to retain sixteen (16) 2.5″ tool bits at eight (8) channels.

In another exemplary non-limiting embodiment, the tool holder 58 is configured substantially as depicted in FIGS. 10-12, and further configured to receive eight (8) 2.5″ tool bits configured as P1, P2, SL 3/16″, SL ¼″, T20, T25, SQ1, SQ2, T7, T8, T9, T10, T15, T25, T27, T30, or combinations thereof. For instance, tool bits 72 may be positioned in each channel 70 to retain eight (8) 2.5″ tool bits at eight (8) channels.

Various embodiments of tool holder 58 depicted and described herein may furthermore include a tool bit stored within bore 61. Accordingly, exemplary embodiments provided herein may be configured to receive eight (8) tool bits at channels 70 formed by wings 68, and an additional tool bit within bore 61, for the tool holder 58 and tool storage device 50 to retain nine (9) tool bits. Still further exemplary embodiments provided herein may be configured to receive sixteen (16) tool bits at channels 70 formed by wings 68, and an additional tool bit within bore 61, for the tool holder 58 and tool storage device 50 to retain seventeen (17) tool bits.

Referring back to FIGS. 1-9, ranges and ratios at body 10 or cap 16 may advantageously and beneficially receive embodiments of the tool holder 58 and tool storage device 50 such as described herein. Embodiments of body 10 or cap 16 may furthermore receive embodiments of the tool holder 58 and tool storage device 50 as a compact hand tool 100 or modular bit storage device 90. Various embodiments depicted and described herein may allow for high-density stacking of tool bits within the body, such as in adjacent circumferential and/or longitudinal arrangement (e.g., double-stacked along the longitudinal direction). Embodiments provided herein may provide benefits and advantages to a user having more tools to selectively choose from, or allowing for customization and variety of tools as desired by the user.

In various embodiments, in a closed, installed position such as depicted in FIG. 1 and FIGS. 3-4, body 10 includes a first length 101 from bottom wall 53 of cap 52 to an internal end wall 84 of the interior volume 82. Body 10 includes a second length 102 from bottom wall 53 to the first end opening 14. Body 10 includes a third length 103 from second end opening 12 to first end opening 14. Various embodiments of body 10 include a ratio of first length 101 to second length 102 between approximately 70% and approximately 80%, or between approximately 74% and approximately 78%, or 76%+/−2%, or +/−6%. For instance, first length 101 may be between approximately 70% and approximately 80% of the second length 102. Various embodiments of body 10 include a ratio of third length 103 to first length 101 between approximately 85% and approximately 91%. For instance, third length 103 may be between approximately 85% and approximately 91% of the first length 101. Ranges and ratios provided herein promote advantageous and beneficial ranges of length to receive the tool holder 58 in the interior volume 82 of the body 10 and allow a user to utilize the body 10 as a hand tool 100.

In an exemplary embodiment, body 10 includes first length 101 of approximately ninety-six (96) millimeters and second length 102 of approximately one-hundred and twenty six (126) millimeters. In an exemplary embodiment, body 10 includes third length 103 of approximately eighty-five (85) millimeters.

In an exemplary embodiment, body 10 includes an outer diameter OD between approximately thirty (30) millimeters and approximately forty (40) millimeters. In an exemplary embodiment, outer diameter OD is approximately thirty-three (33) to approximately thirty-eight (38) millimeters. Body 10 may include an inner diameter ID of approximately thirty (30) millimeters. The inner diameter ID forms a cavity wall 86 of the interior volume 82 at which the tool holder 58 is positioned within the body 10.

In still various exemplary embodiments, body 10 of the modular bit storage device 90 includes outer diameter OD of approximately thirty-three (33) millimeters. A protruding rib formed from the radially extended face 13 forms an outer diameter of approximately thirty-seven (37) millimeters. Body 10 includes an overall length from the second end opening 12 to the closed end 15 between approximately eighty-nine (89) millimeters and approximately ninety-three (93) millimeters, or approximately 90.5 millimeters.

In various embodiments, body 10 includes a wall thickness between approximately 1.5 millimeters and approximately four (4) millimeters.

In various exemplary embodiments, body 10 forms the interior volume 82 having approximately three (3) cubic inches. For instance, interior volume 82 may correspond to a fourth length 104 extending from the second end opening 12 to the internal end wall 84.

In still various exemplary embodiments, body 10 forms an overall volume of approximately 5.3 cubic inches. For instance, embodiments of the body 10 may form an overall volume at which quantities of tool bits such as described herein may be received (e.g., eight tool bits, or sixteen tool bits, or seventeen tool bits, and the like). The user may beneficially and advantageously select from a maximum quantity of tool bits from within the volume.

It should be appreciated that embodiments of the body 10, including dimensions, ranges, ratios, and the like depicted and described herein may form one or more embodiments of the cap 16 of the modular bit storage device 90.

Referring to FIGS. 1-6, exemplary embodiments of the hand tool 100 include body 10 forming a taper or reduced outer diameter OD at length 101, 103, such as corresponding along the longitudinal direction L approximately to the internal end wall 84 of the interior volume 82. Body 10 may be configured to receive a tool head retainer 21 extending substantially from the internal end wall 84 or closed end 15 of the body 10. The tool head retainer 21 forms a portion at which head 20 and key 34 is receivable and retained at body 10. A taper or reduced outer diameter OD such as described may promote grip, rotation, and user handling of the hand tool 100. Lengths, ratios, and ranges such as described herein may further promote storing of the tool bits such as described herein while further promoting grip, rotation, and user handling of the body 10 as a portion of the hand tool 100.

Referring to FIG. 21, an exemplary embodiment of the tool storage system 95 is depicted. The tool storage system 95 may include one or more embodiments of the hand tool 100 and one or more embodiments of the modular bit storage device 90 such as depicted and described herein. In various embodiments, tool storage device 50 may include any one or more embodiments depicted and described herein. In some embodiments, the tool storage system 95 may include the hand tool 100, the bit storage device 90, and the tool storage device 50 selectively positionable at the hand tool 100 and the bit storage device 90 such as depicted and described herein.

Embodiments of the tool storage device 50 provided herein may allow a user to store and retrieve a plurality of tool bits, including tool bits of various dimensions, such as from an interior of the body 10 or cap 16 of embodiments of hand tool 100 and modular bit storage device 90 such as provided herein. Embodiments of the hand tool 100 or modular bit storage device 90 may allow a user to customize the type or variety of tool bits stored at the hand tool or storage device. Embodiments of the body 10, the cap 16, or both, may be at least partially transparent, such as to allow a user to see through body or cap into the interior volume. The user may see through the body or cap to see which tool bit(s) are within the interior volume without requiring opening or removing of the tool holder from the body or cap. Embodiments such as described herein may facilitate quick access and recall of desired tool bits by a user.

Further aspects and embodiments of the present disclosure are provided in the following clauses:
1. A tool storage device, the tool storage device including a base including a shaft extending from an interior surface; and a tool holder coupled to the shaft, the tool holder including a plurality of wings extending radially outward relative to the shaft and along a longitudinal direction, wherein a plurality of channels is formed between respective pairs of wings of the plurality of wings and extending along the longitudinal direction, and wherein the plurality of channels is positioned in adjacent circumferential arrangement, the tool holder forming a center bore into which the shaft is positionable and fastened to the tool holder.
2. The tool storage device of any one or more clauses herein, the tool holder including eight channels in circumferential arrangement formed between pairs of wings.
3. The tool storage device of any one or more clauses herein, the tool holder including a divider extending from a centerline axis extending along the longitudinal direction, wherein the plurality of wings extends along the longitudinal direction from a first portion and a second portion of the divider.
4. The tool storage device of any one or more clauses herein, the tool holder including two pair of eight channels in circumferential arrangement formed between pairs of wings, wherein a first set of eight channels is formed extended along the longitudinal direction from the first portion, and wherein a second set of eight channels is formed extending along the longitudinal direction from the second portion.
5. The tool storage device of any one or more clauses herein, wherein a ratio of an outer diameter of the tool holder extending from a centerline axis to a length of wing along the longitudinal direction is approximately 27:37.
6. The tool storage device of any one or more clauses herein, wherein a ratio of an outer diameter of the tool holder extending from a centerline axis to a length of wing along the longitudinal direction is approximately 1:1.
7. The tool storage device of any one or more clauses herein, including a fastener extending into a center bore at the shaft, wherein the center bore at the shaft is configured to receive threads at the fastener and position a portion of the tool holder between a fastener head and the shaft along the longitudinal direction.
8. The tool storage device of any one or more clauses herein, wherein the base forms a rib at the interior surface, the rib extending between the shaft and a perimeter wall of the base.
9. The tool storage device of any one or more clauses herein, wherein the rib corresponds in circumferential location to the channel formed between the pair of wings.
10. The tool storage device of any one or more clauses herein, wherein the plurality of wings is positioned in circumferential arrangement relative to a centerline axis and around the center bore.
11. The tool storage device of any one or more clauses herein, wherein the plurality of wings forms an outer diameter of the tool holder.
12. The tool storage device of any one or more clauses herein, wherein a ratio of the outer diameter of the tool holder to a length of wing along the longitudinal direction is approximately 27:37.
13. The tool storage device of any one or more clauses herein, wherein a ratio of the outer diameter of the tool holder to a length of wing along the longitudinal direction is approximately 1:1.
14. A modular bit storage system, the system including a cap forming an interior volume into which the tool storage device of any one or more clauses herein is positionable through an opening, wherein the cap is elongated along the longitudinal direction, the cap including an internal end wall, wherein the interior volume extends between the base of the tool storage device and the internal end wall.
15. The modular bit storage system of any one or more clauses herein, wherein a first length is formed from a bottom wall at the base of the tool storage device to the internal end wall at the interior volume of the cap, and wherein a second length is formed from the opening through which the tool storage device extends into the cap to a distal end of the cap along the longitudinal direction, and wherein the first length is between approximately 70% and approximately 80% of the second length.
16. The modular bit storage system of any one or more clauses herein, wherein the cap forms an inner diameter of approximately thirty millimeters.
17. A hand tool, the hand tool including a body forming an interior volume into which the tool storage device of any one or more clauses herein is positionable through an opening, wherein the body is elongated along the longitudinal direction, the body including an internal end wall, wherein the interior volume extends between the base of the tool storage device and the internal end wall, and wherein the body includes a tool head retainer distal along the longitudinal direction from the opening through which the tool storage device is positionable into the body, wherein the tool head retainer is configured to receive a tool head at which a tool bit is receivable.
18. The hand tool of any one or more clauses herein, wherein a first length is formed from a bottom wall at the base of the tool storage device to the internal end wall at the interior volume of the body, wherein a second length is formed from the opening through which the tool storage device extends into the body to a distal end of the body along the longitudinal direction, and wherein the second length is between approximately 85% and approximately 91%.
19. The hand tool of any one or more clauses herein, wherein the body forms a taper at an outer diameter of the body extending along the longitudinal direction, wherein the taper is formed along the longitudinal direction corresponding to the internal end wall at the interior volume of the body.
20. The hand tool of any one or more clauses herein, wherein the tool head retainer is positioned along the longitudinal direction from the taper at the body.
21. The hand tool of any one or more clauses herein, wherein the hand tool is a screwdriver.
22. A tool storage system including the tool storage device of any one or more clauses herein, the hand tool of any one or more clauses herein, and the modular bit storage system of any one or more clauses herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A tool storage device, the tool storage device comprising:
a base comprising a shaft extending from an interior surface; and
a tool holder coupled to the shaft, the tool holder comprising a plurality of wings extending radially outward relative to the shaft and along a longitudinal direction, wherein a plurality of channels is formed between respective pairs of wings of the plurality of wings and extending along the longitudinal direction, and wherein the plurality of channels is positioned in adjacent circumferential arrangement, the tool holder forming a center bore into which the shaft is positionable and fastened to the tool holder.

2. The tool storage device of claim 1, the tool holder comprising eight channels in circumferential arrangement formed between pairs of wings.

3. The tool storage device of claim 1, wherein the plurality of wings extends along the longitudinal direction from a first portion and a second portion of a divider.

4. The tool storage device of claim 3, the tool holder comprising two pair of eight channels in circumferential arrangement formed between pairs of wings, wherein a first set of eight channels is formed extended along the longitudinal direction from the first portion, and wherein a second set of eight channels is formed extending along the longitudinal direction from the second portion.

5. The tool storage device of claim 3, wherein a ratio of an outer diameter of the tool holder extending from a centerline axis to a length of wing along the longitudinal direction is approximately 27:37.

6. The tool storage device of claim 1, wherein a ratio of an outer diameter of the tool holder extending from a centerline axis to a length of wing along the longitudinal direction is approximately 1:1.

7. The tool storage device of claim 1, comprising:
a fastener extending into a center bore at the shaft, wherein the center bore at the shaft is configured to receive threads at the fastener and position a portion of the tool holder between a fastener head and the shaft along the longitudinal direction.

8. The tool storage device of claim 1, wherein the base forms a rib at the interior surface, the rib extending between the shaft and a perimeter wall of the base.

9. The tool storage device of claim 8, wherein the rib corresponds in circumferential location to the channel formed between the pair of wings.

10. The tool storage device of claim 1, wherein the plurality of wings is positioned in circumferential arrangement relative to a centerline axis and around the center bore.

11. The tool storage device of claim 10, wherein the plurality of wings forms an outer diameter of the tool holder.

12. The tool storage device of claim 11, wherein a ratio of the outer diameter of the tool holder to a length of wing along the longitudinal direction is approximately 27:37.

13. The tool storage device of claim 11, wherein a ratio of the outer diameter of the tool holder to a length of wing along the longitudinal direction is approximately 1:1.

14. A tool storage system, the system comprising:
a tool storage device comprising a base and a tool holder, the base comprising a shaft extending from an interior surface, the tool holder coupled to the shaft, the tool holder comprising a plurality of wings extending radially outward relative to the shaft and along a longitudinal direction, wherein a plurality of channels is formed between respective pairs of wings of the plurality of wings and extending along the longitudinal direction, and wherein the plurality of channels is positioned in adjacent circumferential arrangement, the tool holder forming a center bore into which the shaft is positionable and fastened to the tool holder;
a cap forming a cap interior volume into which the tool storage device is positionable through a cap opening, wherein the cap is elongated along the longitudinal direction, the cap comprising a cap internal end wall, wherein the cap interior volume extends between the base of the tool storage device and the cap internal end wall; and
a hand tool, the hand tool comprising a body forming a body interior volume into which the tool storage device is positionable through a body opening, wherein the body is elongated along the longitudinal direction, the body comprising a body internal end wall, wherein the body interior volume extends between the base of the tool storage device and the body internal end wall, and wherein the body comprises a tool head retainer distal along the longitudinal direction from the body opening through which the tool storage device is positionable into the body, wherein the tool head retainer is configured to receive a tool head at which a tool bit is receivable.

15. The tool storage system of claim 14, wherein a first length is formed from a bottom wall at the base of the tool storage device to the internal end wall at the interior volume of the cap, and wherein a second length is formed from the opening through which the tool storage device extends into the cap to a distal end of the cap along the longitudinal direction, and wherein the first length is between approximately 70% and approximately 80% of the second length.

16. The tool storage system of claim 14, wherein the cap forms an inner diameter of approximately thirty millimeters.

17. A hand tool, the hand tool comprising:
a tool storage device comprising a base and a tool holder, the base comprising a shaft extending from an interior surface, the tool holder coupled to the shaft, the tool holder comprising a plurality of wings extending radially outward relative to the shaft and along a longitudinal direction, wherein a plurality of channels is formed between respective pairs of wings of the plurality of wings and extending along the longitudinal direction, and wherein the plurality of channels is positioned in adjacent circumferential arrangement, the tool holder forming a center bore into which the shaft is positionable and fastened to the tool holder; and
a body forming an interior volume into which the tool storage device is positionable through an opening, wherein the body is elongated along the longitudinal direction, the body comprising an internal end wall, wherein the interior volume extends between the base of the tool storage device and the internal end wall, and wherein the body comprises a tool head retainer distal along the longitudinal direction from the opening through which the tool storage device is positionable into the body, wherein the tool head retainer is configured to receive a tool head at which a tool bit is receivable.

18. The hand tool of claim 17, wherein a first length is formed from a bottom wall at the base of the tool storage device to the internal end wall at the interior volume of the body, wherein a second length is formed from the opening through which the tool storage device extends into the body to a distal end of the body along the longitudinal direction, and wherein the second length is between approximately 85% and approximately 91%.

19. The hand tool of claim 17, wherein the body forms a taper at an outer diameter of the body extending along the longitudinal direction, wherein the taper is formed along the longitudinal direction corresponding to the internal end wall at the interior volume of the body.

20. The hand tool of claim 19, wherein the tool head retainer is positioned along the longitudinal direction from the taper at the body.
